(19) United States
(12) Patent Application Publication
(10) Pub. No.: US 2025/0008876 A1
(43) Pub. Date: Jan. 9, 2025

(54) AUTOMATED PICKING APPARATUS FOR FRUITS AND OTHER DELICATE OBJECTS AND METHOD THEREFOR

(71) Applicant: DAXO Industries, Inc., Philadelphia, PA (US)

(72) Inventor: Jiahao Zhang, Philadelphia, PA (US)

(73) Assignee: DAXO Industries, Inc., Philadelphia, PA (US)

(21) Appl. No.: 18/765,150

(22) Filed: Jul. 5, 2024

Related U.S. Application Data
(60) Provisional application No. 63/511,967, filed on Jul. 5, 2023.

(51) Int. Cl. A01D 46/30; A01D 46/253

(52) U.S. Cl. CPC A01D 46/30; A01D 46/253

(57) ABSTRACT

An automated fruit picking apparatus including a stereo camera to determine accurate information regarding a location of fruit on trees and a vacuum picking device that automatically moves toward discovered fruit hanging from a tree based on the determined location of the fruit and to make contact with and pick the fruit off the tree, and a method of automatically picking fruit from a tree.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71 (d).

### BACKGROUND OF THE INVENTIVE CONCEPT

### 1. Field of the Invention

The present inventive concept relates to an automated fruit picking apparatus to seek out fruits on trees and bushes, and to pick discovered fruit off a tree or bush. More particularly, but not exclusively, this inventive concept relates to an automated picking apparatus to seek out fruits on trees and bushes, and to pick discovered fruit off a tree or bush by automatically searching for fruit, reaching discovered fruit, capturing the discovered fruit and picking the discovered fruit from a tree or bush.

### DESCRIPTION OF THE RELATED ART

Fruit picking apparatus and systems are essential to help pick fruits of trees, especially when the fruits are high up in a bush or tree outside the reach of a human. Further, even in cases where fruit picking apparatuses and systems are capable of reaching fruits hanging high up in trees or bushes, automated systems controlling these fruit picking apparatuses and systems are not capable of zoning in on a piece of fruit within reach.

U.S. Pat. No. 4,975,016 by Pellenc et al. teaches an automated machine for detection and grasping of objects. Here, although a folding arm 2 can move an intake head 21 toward a piece of fruit, there is no control over the intake head 21 to specifically move toward a piece of fruit or to pivot in any direction to face a piece of fruit, thus being limited to a very basic manual operation of attempting to get the intake head 21 to line up with and accurately capture a piece of fruit using only bulky folding arm 2.

U.S. Patent Publication Number: 2021/0267125A1 by Lu et al. teaches the use of a camera 12 to identify the location of fruit, and a controller 14 to process camera images and communicate control instructions to move a vacuum operated selection tube 18 to approach fruit A and attempt to draw fruit A to the tube 18. Here the tube 18 is positioned toward a piece of fruit A in the hopes that a fruit gripping orifice 34 will grip and seal a targeted fruit A. However, the directing of the tube 18 is very limited to gliding a sliding base 22 along a slotted track 24. There is no accurate control of a fruit gripping device to reach out to a piece of fruit and position itself to face the piece of fruit to ensure capturing the fruit.

Accordingly, there is a need for an automated fruit picking apparatus that can detect an accurate location of a piece of fruit and then extend a suction or gripping device out toward the detected piece of fruit, and then position the suction or gripping device to face the detected piece fruit.

There is also a need for a fruit detection system that can detect the size, variety and color of a piece of fruit during a picking process and store the detected information in a Cloud storage.

There is also a need for an automated fruit picking system that can detect fruit and capture image data of the detected fruit, reach out toward the detected fruit, position a suction or gripping unit to face the detected fruit, securely grip the fruit, pull gripped fruit from a tree, drop the captured fruit into a chute and transport the captured fruit.

### SUMMARY OF THE INVENTIVE CONCEPT

The present general inventive concept provides an automated picking apparatus to seek out fruits on trees and pick discovered fruit off a tree by automatically searching for fruit, reaching discovered fruit, capturing the discovered fruit and picking the discovered fruit from a tree.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an automated fruit picking apparatus, comprising: a main body formed of a rigid material; at least two shooter assemblies fixed to different sides of the main body, the at least two shooter assemblies each including: a shooter extender housing attached to a side of the main body; at least one pair of rotatable guide bearings disposed adjacent to each other within the shooter extender housing to guide movement of a flexible cable to extend out through and retract back through the shooter extender housing; a driver roller configured to drive a flexible cable back and forth through the shooter extender housing between the at least one pair of rotatable guide bearings; a driver motor connected to the shooter extender housing and to the driver roller to rotate the driver roller; and an integrated digitally programmed rotary encoder to control rotation of the driver motor; a flexible cable extending through each of the at least two shooter assemblies between the at least one pair of guide bearings and against the drive roller; a cable adapter assembly connected at a first side thereof to a first end of each flexible cable; a vacuum cup connected to a second side of the cable adapter assembly; and a stereo vision camera connected to a front of the main body to sense a position of a piece of fruit, to capture image data of the piece of fruit, and to send the captured image data to the integrated digitally programmed rotary encoder to control rotation of each drive motor of the at least two shooter assemblies to control positioning of the cable adaptor assembly and vacuum cup.

In an exemplary embodiment, the at least two shooter assemblies includes four shooter assemblies, each shooter assembly being fixed to a different side of the main body.

In another exemplary embodiment, the automated fruit picking apparatus can further include: a reset trigger attached to the flexible cable between one side of the corresponding shooter extender housing and the cable adapter assembly; a cable end stopper attached to the flexible cable at an opposite side of the corresponding shooter extender housing; and a trigger limit switch to trigger and stop the drive motor when the trigger limit switch detects the reset trigger indicating that the flexible cable has been fully retracted through the shooter extender housing and when the trigger limit switch detects the cable end stopper indicating that the flexible cable has been fully extended through the shooter extender housing.

In another exemplary embodiment, the at least one pair of guide bearings disposed adjacent to each other includes two pairs of guide bearings, a first pair of guide bearings being disposed at a first end of the shooter extender housing and a second pair of guide bearings being disposed at a second opposite end of the shooter extender housing such that the corresponding flexible cable extends through each of the pairs of the guide bearings and the drive roller is disposed between the first and second pair of guide bearings.

In another exemplary embodiment, the automated fruit picking apparatus can further include: a compression joint assembly disposed against the drive roller to apply a compression force on the flexible cable to stay in frictional contact with the drive roller.

In still another exemplary embodiment, the compression joint assembly can include: a compression bracket rotatably supporting and compressing a guide bearing to press a flexible cable against the drive roller; a compression spring to apply a compression force between the main body and the compression bracket; and a spring adjuster to adjust the compression force applied by the compression spring.

In still another exemplary embodiment, the main body can be formed of sheet metal.

In yet another exemplary embodiment, the automated fruit picking apparatus can further include: a computer operated robotic arm assembly connected thereto to the main body to raise and lower the main body based on image data received from the stereo vision camera.

The foregoing and/or other features and utilities of the present general inventive concept may also be achieved by providing an automated fruit picking system, comprising: a main body having four sides; a shooter assembly fixed to each of the four sides of the main body, each shooter assembly including: a shooter extender housing attached to one side of the main body; a driver roller rotatably fixed to the shooter extender housing and configured to frictionally drive a flexible cable to extend out through the shooter extender housing and retract back through the shooter extender housing; a compression assembly fixed to the shooter extender housing to apply a continuous force to a flexible cable against the drive roller; and a digitally controlled rotary encoder driver motor connected to the main body and the driver roller to control precise rotation of the driver roller; a flexible cable extending between the drive roller and the compression assembly; a cable adapter assembly connected at a first side thereof to a first end of each flexible cable; a fruit suction device to suction fruit thereto connected to a second side of the cable adapter assembly; and a stereo vision camera connected to a front end of the main body to sense a position of a piece of fruit, to capture image data of the piece of fruit, and to send the captured image data to each digitally controlled rotary encoder driver motor to control rotation of each digitally controlled rotary encoder driver motor to control positioning of each corresponding flexible cable, the cable adaptor assembly and the vacuum cup.

In an exemplary embodiment, the automated fruit picking system can further comprise: an adjacent pair of rotatable guide bearings disposed at two opposite sides of the driver roller and compression assembly combination to each receive the flexible cable therebetween to guide the movement of the flexible cable to extend out through the shooter extender housing and retract back through the shooter extender housing.

In another exemplary embodiment, the automated fruit picking system can further comprise: a reset trigger attached to the flexible cable between one side of the corresponding shooter extender housing and the cable adapter assembly; a cable end stopper attached to the flexible cable at an opposite side of the corresponding shooter extender housing; and a trigger limit switch to trigger and stop the drive motor when the trigger limit switch detects the reset trigger indicating that the flexible cable has been fully retracted through the shooter extender housing and when the trigger limit switch detects the cable end stopper indicating that the flexible cable has been fully extended through the shooter extender housing.

In still another exemplary embodiment, the compression joint assembly can comprise: a compression bracket rotatably supporting and compressing a guide bearing to press a flexible cable against the drive roller; a compression spring to apply a compression force between the main body and the compression bracket; and a spring adjuster to adjust the compression force applied by the compression spring.

In still another exemplary embodiment, the fruit suction device is a vacuum cup configured to draw air inward through the vacuum cup to suction the fruit.

The foregoing and/or other features and utilities of the present general inventive concept may also be achieved by providing a method of automatically picking fruit from a tree, the method comprising: controlling the extension, retraction and the positional direction of the vacuum cup assembly by: capturing image data of a location of a piece of fruit with an image capturing device; transmitting the captured image data to at least two digitally controlled rotary encoded driver motors, the image data being executed to control the rotation of the at least two digitally controlled rotary encoded driver motors; rotating at least two driver rollers by the corresponding at least two digitally controlled rotary encoded driver motors to rotate a corresponding driver roller to frictionally extend and retract a corresponding flexible cable; and extending, retracting and pointing the vacuum cup assembly in different directs with the extension and retraction of each flexible cable by connecting each flexible cable to a different location on the vacuum cup assembly.

In an exemplary embodiment, the method may further comprise: guiding the flexible cables through two pairs of guide bearings, each pair of guide bearings receiving a corresponding flexible cable therethrough to guide the direction of the corresponding flexible cable.

In still another exemplary embodiment, the method may further comprise: applying a continuous compression force to the flexible cable against the corresponding driver roller to maintain a friction between the flexible cable and the driver roller.

In yet another exemplary embodiment, the method may further comprise: raising and lowering the vacuum cup assembly, the image capturing device, the at least two digitally controlled rotary driver motors and corresponding driver roller with a computer controlled robotic arm assembly in accordance with the captured image data.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a perspective view of an automated picking apparatus according to an example embodiment of the present inventive concept;

FIG. 2 illustrates a perspective view of components of the automated picking apparatus in accordance with the exemplary embodiment of FIG. 1;

FIG. 3 illustrates a side view of components of the automated picking apparatus in accordance with the exemplary embodiment of FIG. 1;

FIG. 4 illustrates a front view of the automated picking apparatus in accordance with the exemplary embodiment of FIG. 1;

FIG. 5 illustrates an assembled operational perspective view of a shooter assembly within the automated picking apparatus, according to an example embodiment of the present inventive concept;

FIG. 6 illustrates an exploded perspective view of the shooter assembly in accordance with the exemplary embodiment of FIG. 5;

FIG. 7 illustrates an assembled operational side view of the shooter assembly according to the example embodiment of FIGS. 5 and 6;

FIG. 8 illustrates an assembled operational perspective view of a shooter assembly within the automated picking apparatus of FIG. 1, according to another example embodiment of the present inventive concept;

FIG. 9 illustrates an exploded perspective view of the shooter assembly in accordance with the example embodiment of FIG. 8;

FIG. 10 illustrates an elevated side view of a shooter assembly of FIG. 8, with a flexible cable extending therethrough and a drive motor and corresponding integrated digital rotary encoder connected thereto;

FIG. 11 illustrates an elevated plan view of a completed version of the automated picking apparatus of FIG. 1, according to an example embodiment of the present inventive concept;

FIG. 12 illustrates an example embodiment of a process of operations of the automated picking apparatus; and

FIG. 13 illustrates an automated fruit picking system according to an example embodiment of the present inventive concept.

The drawings illustrate a few exemplary embodiments of the present inventive concept, and are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description provided herein. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” may indicate a unit to process at least one function or operation, wherein the unit and the module may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to an automated picking apparatus to seek out fruits on trees and pick discovered fruit off a tree by automatically searching for fruit, reaching discovered fruit, capturing the discovered fruit and picking the discovered fruit from a tree.

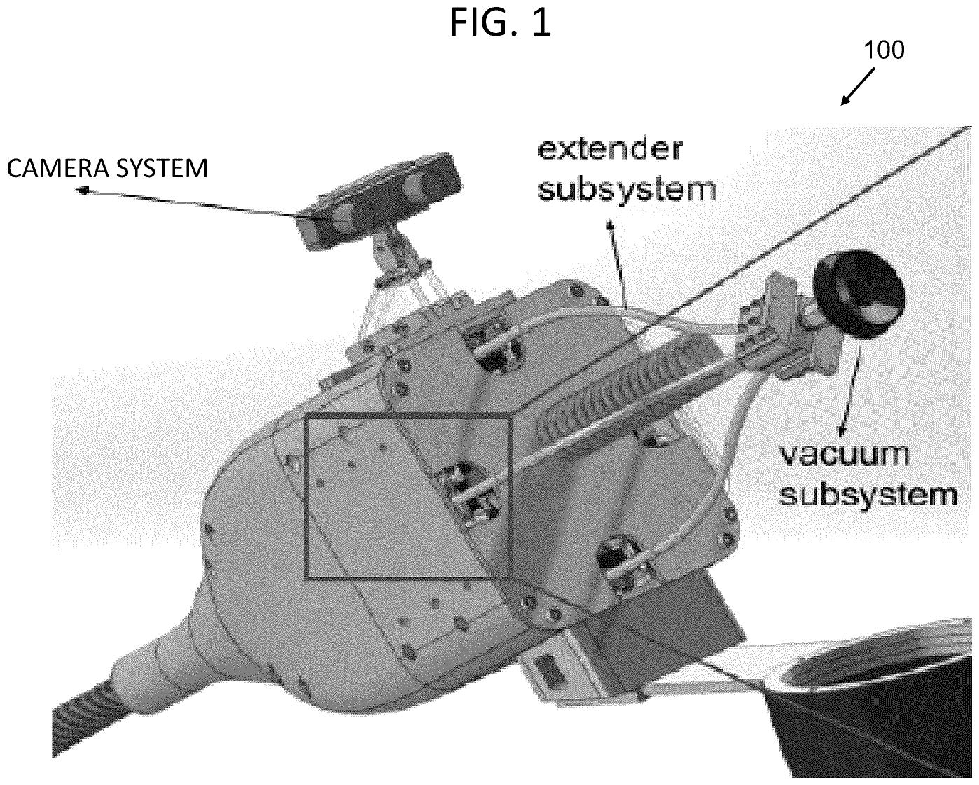

FIG. 1 illustrates an elevated perspective view of an automated picking apparatus 100 according to an example embodiment of the present inventive concept. Referring to FIG. 1, a stereo camera can be provided to detect fruit (or other delicate objects) hanging from a tree. Once the camera discovers a piece of fruit, the camera will transmit image data regarding the position of the fruit to a computer processor system configured to process the transmitted image data in order to determine the exact location of the fruit. The processed image data will then be used to control operations of a vacuum system and a vacuum cup connected to the vacuum system, and a shooter assembly, which will be described in more detail below.

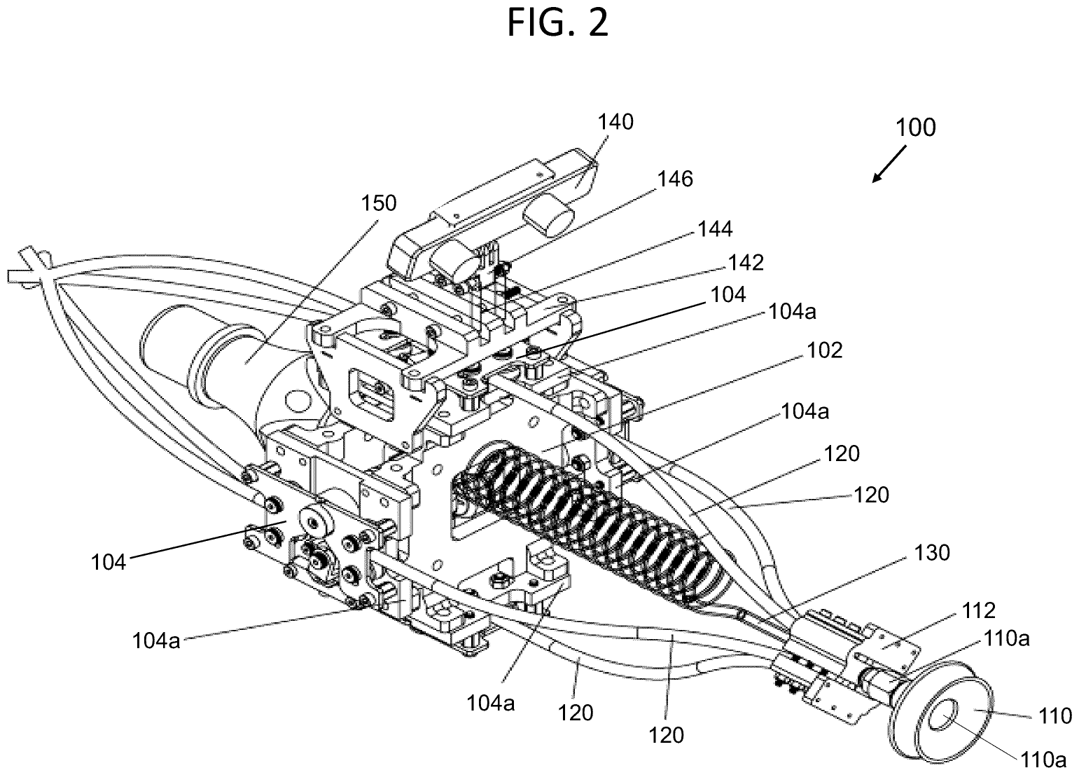

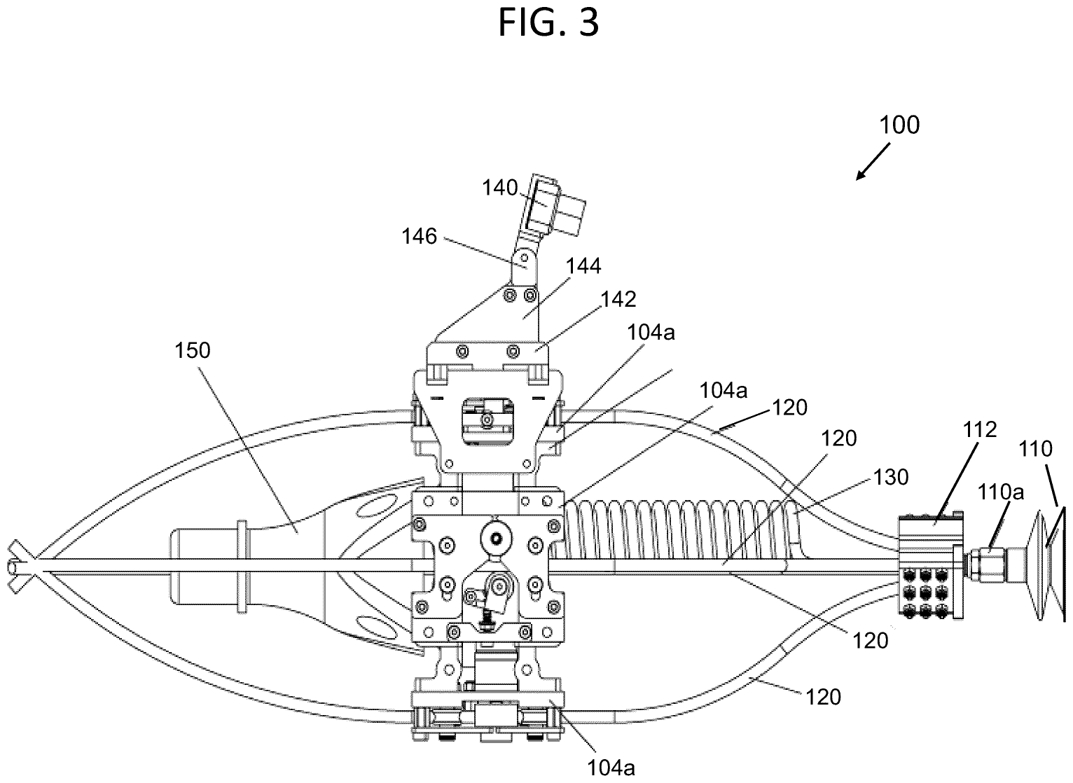

FIG. 2 illustrates a perspective view of the automated picking apparatus 100 and components thereof, in accordance with an example embodiment of the present inventive concept. FIG. 3 illustrates a side view of the automated picking apparatus according to the example embodiment of FIG. 2. Referring to FIGS. 2 and 3, a main body 102 is provided to support a plurality of shooter assemblies 104. According to an example embodiment the main body 102 can include four sides, a front and a back. The main body 102 can be formed of a light metal material or a light composite material. Alternatively, the main body can be formed of any material which will be durable and easy to move around, and which will perform the intended purposes of the present inventive concept, as described herein.

On each of four sides of the main body 102 can be secured a shooter assembly 104. The shooter assemblies 104 can include a shooter assembly base 104a configured to be attachable to a side of the main body 102 to secure the corresponding shooter assembly 104 to the main body 102. It is to be noted that the main body 102 can be formed to have less than or more than four sides, and the number of shooter assemblies 104 to be attached to the main body 102 can vary to correspond with the number of sides of the main body 102, without departing from the spirit and scope of the overall inventive concept.

Extending through each shooter assembly 104 can be provided a flexible cable 120. The flexible cables 120 can be formed of steel or of other flexible, yet rigid material. Alternatively, the flexible cable 120 can be formed of any material which will perform the intended purposes thereof, such as extending outward and being flexible, without departing from the spirit and scope of the overall present inventive concept.

Each flexible cable 120 is attached at a first end thereof to a first end of a cable adapter assembly (or cable aggregator) 112. It is to be noted that each first end of a flexible cable 120 should be attached to an area of the cable adapter assembly 112 separate from another one of the flexible cables 120 such that movement of each flexible cable 120 will cause the cable adapter assembly 112 to move and/or point in different directions. The cable adapter assembly 112 is configured to bind four cables 120 together tightly. A second end of the cable adapter assembly 112 is preferably connected to a vacuum cup 110 via a vacuum cup connector 110a. The vacuum cup connector 110a can be a threaded nut which is rotatably connected to the first end of the cable adapter assembly 112 and configured to be threaded onto a set of threads extending from a rear portion of the vacuum cup 110. Alternatively, a robotic gripper can be used instead of the vacuum cup 110 to grip a piece of fruit.

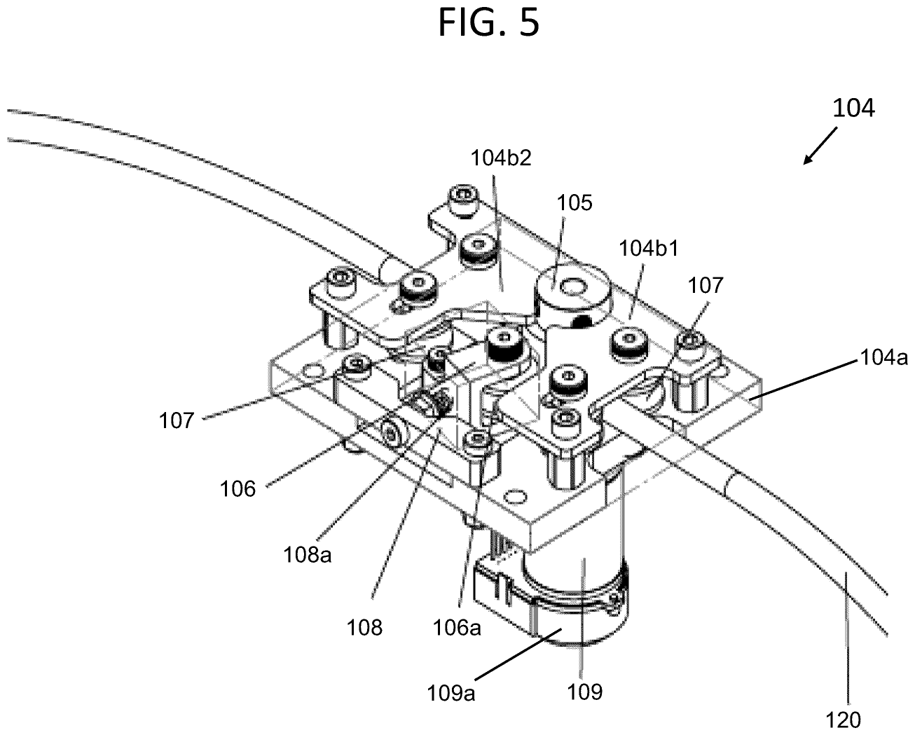

The flexible cables 120 can be fed back and forth (retracted and extended) through the respective shooter assembly 104 via operations of the respective shooter assembly 104 such that the cable adapter assembly 112 and vacuum cup 110 can be moved outward away from the main body 102, as well as being movable to point the vacuum cup 110 upward, downward, left and right, depending on which cable 120 or cables 120 are being moved back and forth by the respective shooter assembly 104. In other words, by extending and retracting each cable 120 for different lengths, the vacuum cup 110 can move around in space in order to place the vacuum cup 110 at the right location with respect to a piece of fruit. Further, by extending specific ones of the cables 120 for different lengths, the vacuum cup 110 can be pointed in a specific direction to zone in on a piece of fruit within the vicinity of the vacuum cup 110. A more detailed description of the shooter assemblies 104 and operations thereof is provided below with reference to FIGS. 5-7.

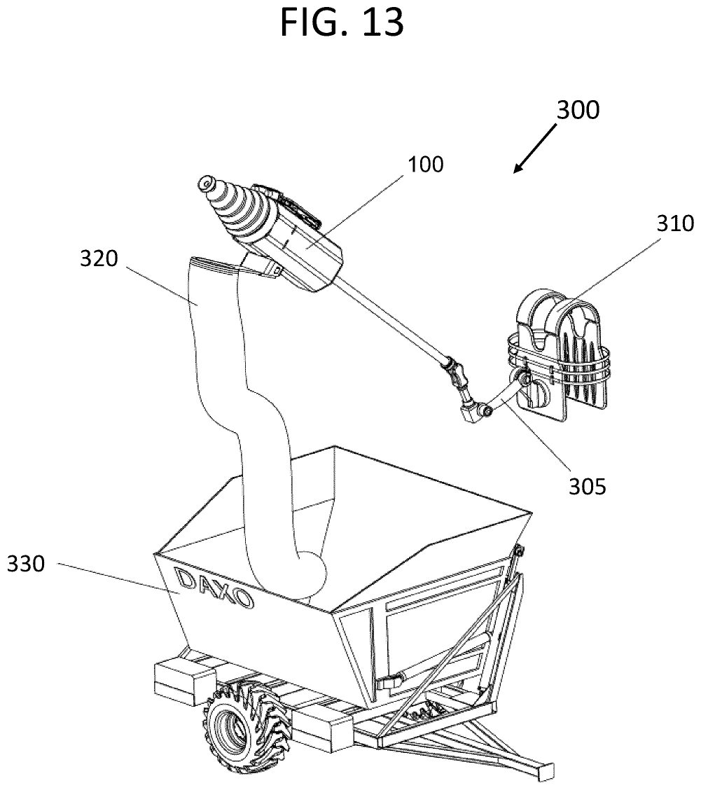

The main body 102 is also connected to an external vacuum system (not illustrated). A flexible vacuum tubing 130 is connected between the external vacuum system and a vacuum cup port 110a of the vacuum cup 110 such that when the vacuum system is turned on by the computer processor system a vacuum will pull air inward through the flexible vacuum tubing 130 and the vacuum cup port 110a to suction and grab a piece of fruit once the vacuum cup 110 reaches out and makes contact with the fruit. Extending from a rear portion of the main body 102 can be provided a connector unit 150. The connector unit 150 can be configured to receive and retain an elongated rod or pole therein such that the automated picking apparatus 100 can be extended up into a tree where high hanging fruit can be found. The connector unit 150 can also be configured to attach to an industrial robotic arm 300 or arms (see, for example, FIG. 13).

A stereo vision camera 140, which can sense both color and depth (RGBD), can be attached to a top side of the main body 102 via a camera mount housing 142. Alternatively, monocular cameras can be installed around the four corners of the apparatus 100, wherein software is configured to achieve the depth sensing operations. More specifically, the camera mount housing 142 can include an adjustable mount 144 disposed thereon as well as a mechanical camera interface 146. The mechanical camera interface 146 attaches to a bottom portion of the camera 140 and is operable to be slidably connected to the adjustable mount 144. It is to be noted that more than one stereo vision camera 140 can be mounted to the main body 102 of the automated picking apparatus 100 for even more accuracy of locating and zoning in on a single piece of fruit.

Once the automated picking apparatus 100 is lifted or extended (by an elongated rod or pole, or by an industrial robotic arm(s)) 300 (see FIG. 13) toward the general area in which a piece of fruit may exist, or even when the automated picking apparatus 100 is pointed toward a branch of a tree or bush bearing fruit, the stereo vision camera 140 will continue to seek out a piece of fruit. Upon the detection of a piece of fruit by the stereo vision camera 140 image data captured by the stereo vision camera 140 regarding a piece of fruit will be transmitted to the computer processor system, which will process the image data received from the camera 140 using a data processor. As the image data from the stereo vision camera 140 is being processed by the data processor within the computer processor system a controller within the computer processor system will use the processed data to generate control signals to control the vacuum system and the plurality of shooter assemblies 104 within the automated picking apparatus 100. More specifically, the controller of the computer processor system will send control signals to the vacuum system to turn on a vacuum suction through the vacuum tubing 130, and hence through the vacuum cup port 110a, and to control the shooter assemblies 104 to move one or more of the flexible cables 120 to point the vacuum cup 110 in the direction of the piece of fruit. At the same time a set of sensors disposed on or near the vacuum cup 110 will sense when the fruit is near the vacuum cup 110 and provide sensor data to the computer processor system, which will process the sensor data and generate control signals to control operations of the shooter assemblies 104 so that the vacuum cup 110 will approach the piece of fruit gently as not to bruise or damage the fruit while engaging the fruit with a circumferential surface of the vacuum cup 110. Among the computer process system can be provided an integrated digital rotary encoder 109a (see FIG. 5) connected to a driver motor 109 described in more detail below.

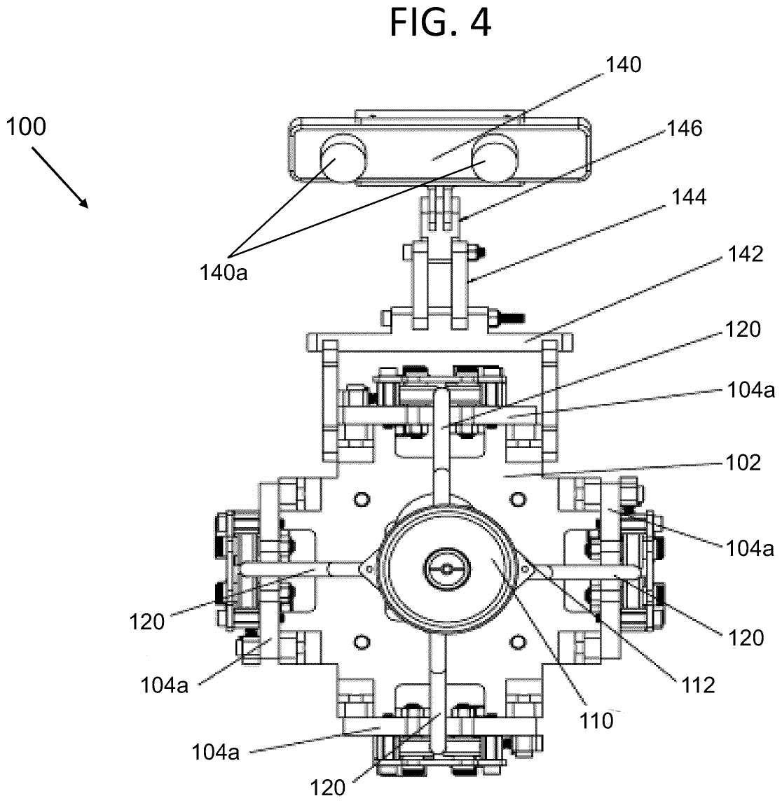

FIG. 4 illustrates a front elevated view of the automated picking apparatus 100 in accordance with an exemplary embodiment of the present inventive concept. Referring to FIG. 4, the stereo vision camera 140 can include one of more lenses 140a to detect fruit and provide image data of detected fruit to the computer processor system. Once the lens or lenses 140a of the stereo vision camera 140 detect fruit the flexible cables 120 can be controlled by the corresponding shooter assemblies 104 to move the vacuum cup 110 in the direction in which fruit has been detected. The stereo vision camera 140 can detect the size, variety, and color of the fruit during the picking process and store this information in the Cloud, which can help with intelligent crop management for growers as part of the precision agricultural practice.

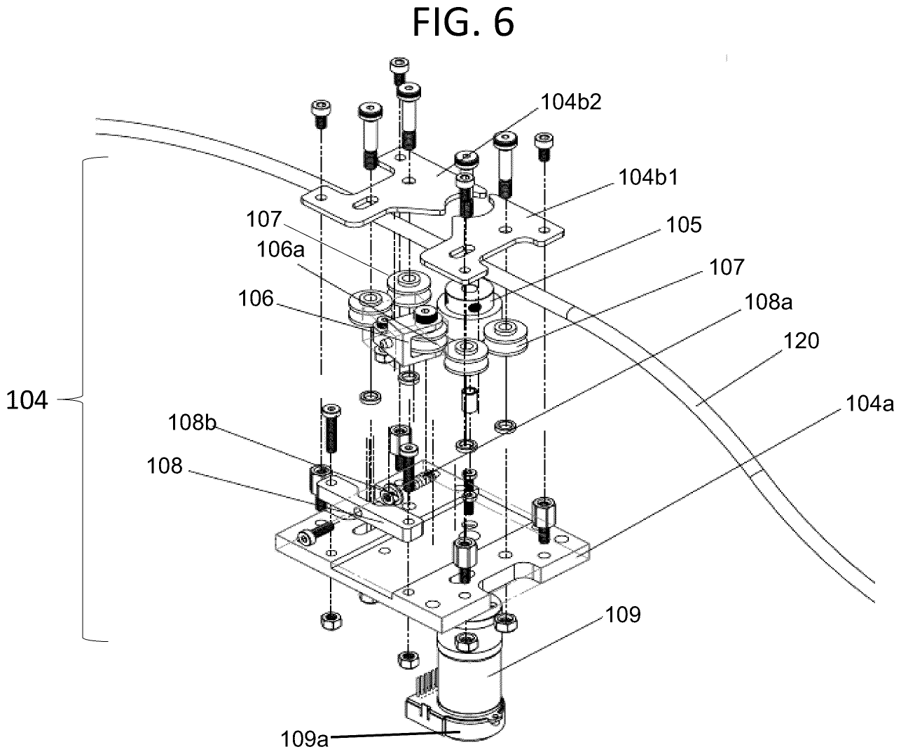

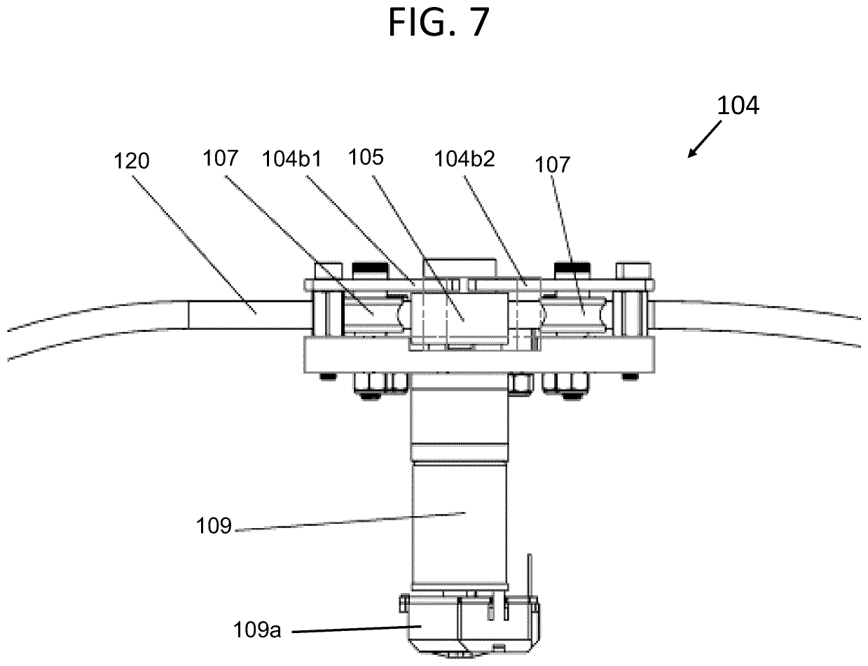

FIG. 5 illustrates an assembled operational perspective view of a shooter assembly within the automated picking apparatus 100, according to an example embodiment of the present inventive concept. As illustrated in FIG. 5, one of the flexible cables 120 of the automated picking apparatus 100 can be controlled to move back and forth within a corresponding shooter assembly 104. Movement of the flexible cable 120 with respect to the respective shooter assembly 104 can be activated by a motor 109 and integrated digital rotary encoder 109a combination. The motor 109 can be either a DC motor, a stepper motor, an AC motor or a servo motor. The motor 109 can be directly connected to a drive roller 105 via a motor shaft (not illustrated) extending a center of the motor 109. Each motor 109 can include a positional integrated rotary encoder 109a to register how much the shaft extending therefrom has rotated, which in turn registers how much the drive roller 105 has rotated. Alternatively, the motor 109 can include external sensors to keep track of the respective cable 120 location. The drive roller 105 can be kept in tight frictional contact with the flexible cable 120 with the aid of a compression joint 106. The drive roller 105 can include a frictional outer surface in order to maintain a frictional grip on the flexible cable 120 as the drive roller 105 is rotated to extend and retract the flexible cable 120. Details of the individual components of the shooter assembly 104 are provided below with reference to FIGS. 6 and 7.

FIG. 6 illustrates an exploded perspective view of the shooter assembly in accordance with the example embodiment of FIG. 5. Referring to FIG. 6, the motor 109 can be disposed at the back of the shooter assembly base 104a and connected to the drive roller 105 via a drive roller shaft (not illustrated) extending from the motor 109 to be inserted through a center of the drive roller 105. The drive roller can be seated at an opposite side of the shooter assembly base 104a with respect to the side of the shooter assembly base 104a at which the motor 109 is disposed. The compression joint 106 can include a U-grooved compression ball bearing 106a which is configured to apply pressure to the cable 120 to remain in tight contact with the drive roller 105. More specifically, according to an example embodiment, a compression wall 108 can be fixed to a top surface of the shooter assembly base 104a where the drive roller 105 and compression joint 106 are seated. The compression wall 108 can include a compression spring 108a disposed between the compression wall 108 and the compression joint 106 such that the compression spring 108a maintains a force against the compression joint 106, which in turn will cause the compression ball bearing 106a to continuously press the cable 120 against the drive roller 105. The compression joint 106 is configured to pivot around and is spring loaded by the compression spring 108a to maintain a pressure against the drive roller 105.

The drive roller 105 preferably includes a frictional or gripping outer surface which will grip the flexible cable 120 and move the flexible cable 120 back and forth as the drive roller 105 rolls in both clockwise and counterclockwise directions. Adjacent to both sides of the drive roller 105 and the compression ball bearing 106a can be disposed a pair of U-grooved ball bearings 107 in rotating contact with each other. Each pair of ball bearings 107 act as a guide by constraining the cable 120 therebetween to ensure guiding the flexible cable 120 in a straight line, to keep the flexible cable 120 from buckling, and to prevent the cables 120 from wiggling during extrusion/extraction thereof, especially when the cables 120 extend outward from the front of the main body 102, which improves the accuracy of motion of the vacuum cup 110a with respect to the fruit to be contacted and picked. Each of the U-shaped ball bearings 107 can be rotatably fixed to the shooter assembly base 104a with a respective screw and nut combination, where the screws can be inserted through first and second top covers 104b1 and 104b2, through a respective ball bearing 107 center hole, and through the shooter assembly base 104a, as illustrated in FIG. 6.

FIG. 7 illustrates an assembled operational side view of the shooter assembly according to the example embodiment of FIGS. 5 and 6. Referring to FIG. 7, the DC motor 109 is connected to the drive roller 105 to rotate the drive roller 105 in clockwise and counterclockwise directions, depending on the control signal received from the computer processor system controller. As the drive roller 105 is being rotated the pairs of ball bearings 107 at each side of the drive roller 105 and the compression ball bearing 106a combination will guide the cable 120 to either extend the vacuum cup 110 away from the main body 102 or back toward the main body 102, depending on whether the camera 140 is providing data to extend outward to make contact with a piece of fruit or providing data to retract inward with a captured piece of fruit.

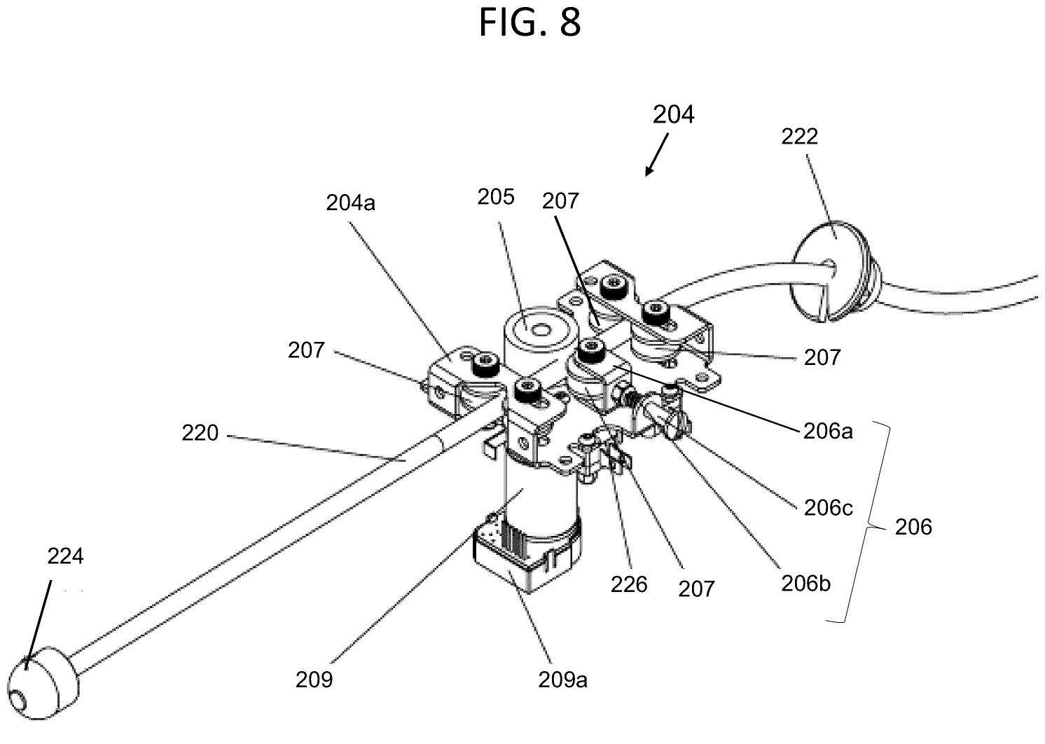

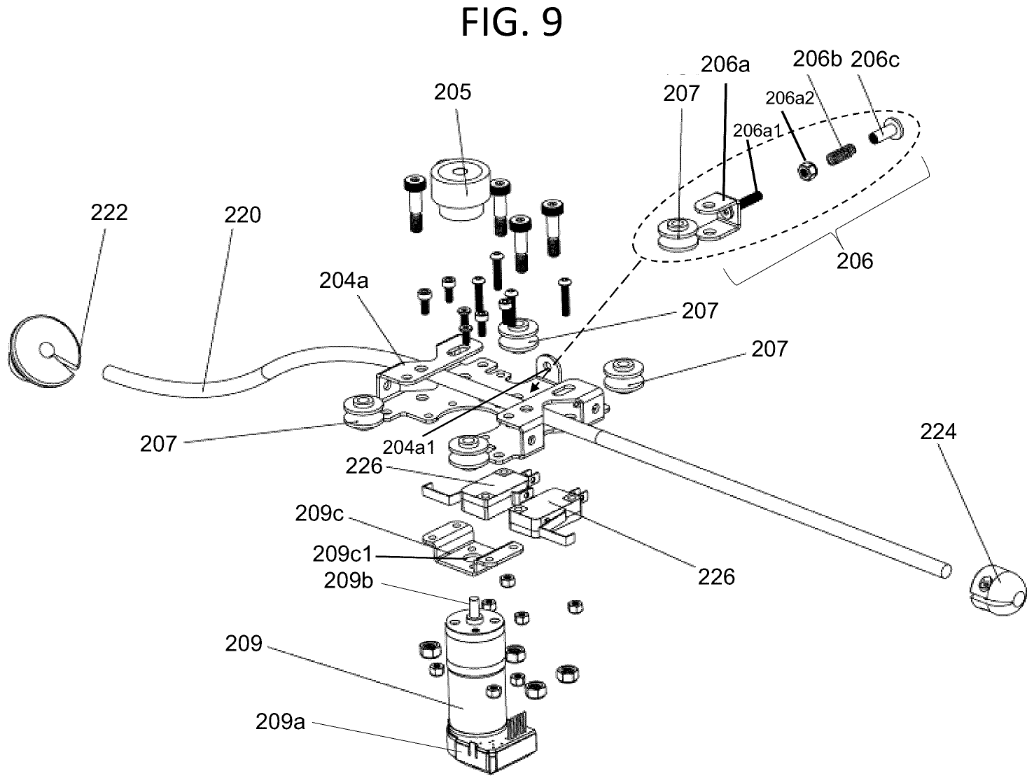

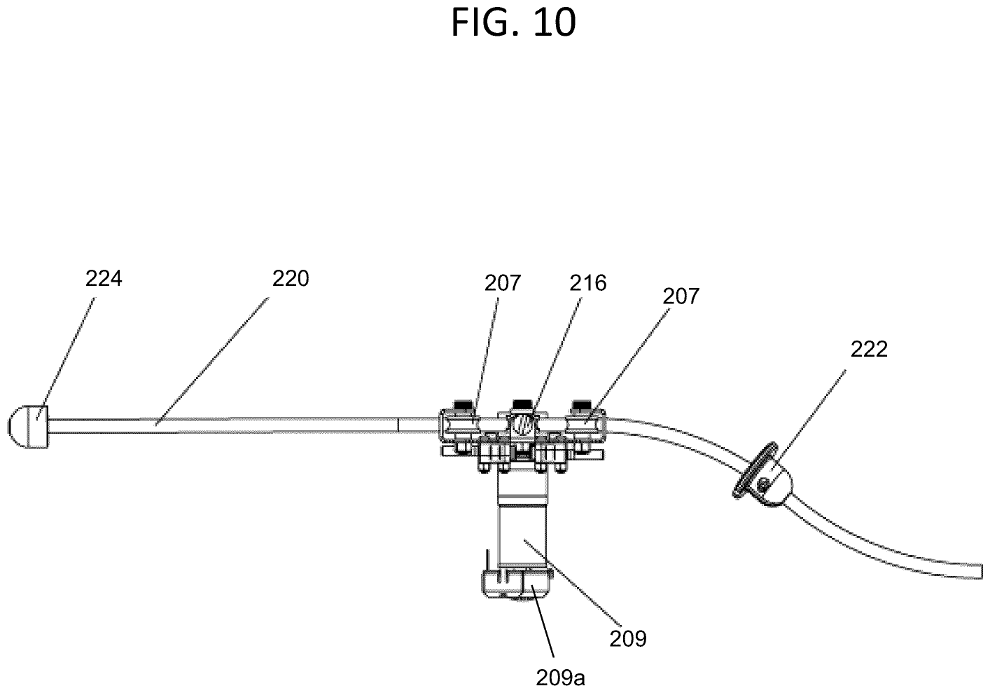

FIG. 8 illustrates an assembled operational perspective view of a shooter assembly 204 within the automated picking apparatus 100, according to another example embodiment of the present inventive concept. According to an example embodiment, there are four shooter assemblies 204, one for each flexible cable 220. As illustrated in FIG. 8, each flexible cable 220 of the automated picking apparatus 100 is controlled to move back and forth within a corresponding shooter assembly 204. Movement of each flexible cable 220 by the respective shooter assembly 204 can be activated by a drive motor 209. The drive motor 209 can be either a DC motor, a stepper motor, an AC motor servo motor. Accurate control of the drive motor 209 can be performed by an integrated digitally programmed rotary encoder 209a connected thereto. Each drive motor 209 can be directly connected to a corresponding drive roller 205 via a drive roller shaft 209b (see FIG. 9) extending from the drive motor 209. The integrated digitally programmed rotary encoder 209a can register how much the shaft extending therefrom has rotated, which in turn registers how much the drive roller 205 has rotated. Alternatively, the drive motor 209 can include external sensors to keep track of the respective cable 220 location. The drive roller 205 can be kept in tight frictional contact with the flexible cable 220 with the aid of a compression joint assembly 206. The drive roller 205 can include a frictional outer surface in order to maintain a frictional grip on the flexible cable 220 as the drive roller 205 is rotated to extend and retract the flexible cable 220. Details of the individual components of the shooter assembly 204 are provided below with reference to FIGS. 9 and 10.

FIG. 9 illustrates an exploded perspective view of the shooter assembly 204 in accordance with the example embodiment of FIG. 8. Referring to FIG. 9, the shooter assembly 204 can include a single shooter extender housing 204a, which can be formed of a single piece of sheet metal, or other equivalent durable materials, such as, for example acetal Delrin or a polycarbonate. The drive motor 209 can be disposed at a back side of the shooter extender housing 204a and connected to the drive roller 205 via the drive roller shaft 209b extending from the drive motor 209. The drive roller 205 can be seated at an opposite side of the shooter extender housing 204a with respect to the side at which the drive motor 209 is disposed. The compression joint assembly 206 can include a compression bracket 206a which is configured to receive a first guide bearing 207 therein and is further configured to securely retain the first guide bearing 207 therein via an axle such that the first guide bearing 207 freely rotates within the compression bracket 206a. The compression joint assembly 206 can also include a threaded screw 206al extending from a back side thereof to be inserted through a hole 204al formed through an upwardly bent portion of the shooter extender housing 204a (see FIG. 9). The compression joint assembly 206 can also include a threaded nut 206a2, a compression spring 206b and a spring adjuster 206c combination, which together maintains the first guide bearing 207 in a spring-loaded state against the drive roller 205. The drive roller 105 preferably includes a frictional or gripping outer surface which will grip the flexible cable 120 and move the flexible cable 120 back and forth as the drive roller 105 rolls in both clockwise and counterclockwise directions via the drive roller shaft 209b of the drive motor 209.

Two opposite ends of the shooter extender housing 204a are formed into a U-shape to receive guide bearings 207 therein. As illustrated in FIGS. 8 and 9 a pair of guide bearings 207 can be rotatably disposed and secured at each of the two opposite sides of the shooter extender housing 204a via corresponding threaded screws. Each pair of guide bearings 207 are configured to receive the flexible cable 220 therebetween to guide the flexible cable 220 as the flexible cable 220 is driven back and forth between the drive roller 205 and compression joint assembly 206. Constant friction can be maintained between the drive roller 205 and the flexible cable 220 via the spring-loaded compression joint assembly 206. The drive roller 205 and compression joint assembly 206 are preferably disposed between the two pairs of guide bearings 207.

Still referring to FIGS. 8 and 9, a pair of limit switches 226 are mounted to the bottom of the shoot extender housing 204a. the pair of limit switches 226 are configured to become triggered by a reset trigger 222 disposed along the flexible cable 220 at one side of the shooter extender assembly 204 and by a cable end stopper 224 disposed along the flexible cable 220 at one side of the shooter extender assembly 204. More specifically, the cable end stopper 224 is disposed along the flexible cable 220 at a position to trigger the limit switches 226 when the flexible cable 220 is fully extended and the reset trigger 222 is disposed along the flexible cable 220 at a position to trigger the limit switches 226 when the flexible cable 220 is fully retracted. The digital rotary encoder 209a is configured to register the number of revolutions in which the drive motor 209 has rotated. A drive motor bracket 209c can be screwed onto the back surface of the shoot extender housing 204a and include a central hole 209cl extending therethrough to receive the drive roller shaft 209b therethrough to maintain a fixed rotational position of the drive roller 205.

FIG. 10 illustrates an elevated side view of a shooter assembly 204 with the flexible cable 220 extending therethrough and the drive motor 209 and corresponding integrated digital rotary encoder 209a connected thereto.

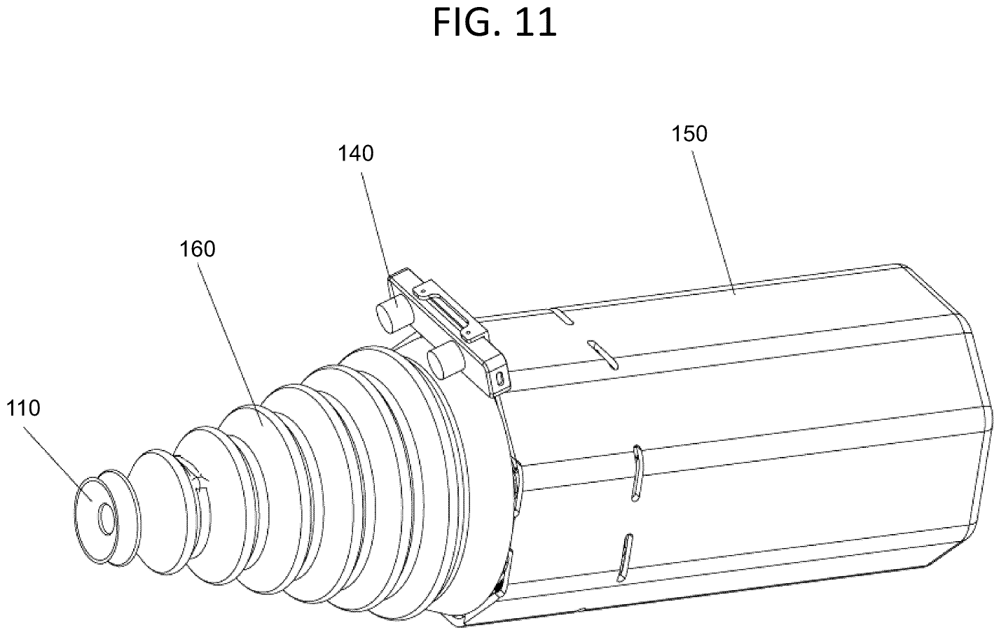

FIG. 11 illustrates an elevated plan view of a completed version of the automated picking apparatus 100, according to an example embodiment of the present inventive concept. The completed version can include a body covering 150 to cover the body portion of the automated picking apparatus 100 and a bellows cover 160 configured to cover the flexible cables 120, 220, the cable adapter assembly 112 and the flexible vacuum tubing 130. Here the bellows cover 160 is disposed between the body covering 150 and the vacuum cup 110. As illustrated, the camera(s) 140 can be fixed to a top of the automated picking apparatus 100 outside of the body covering 150.

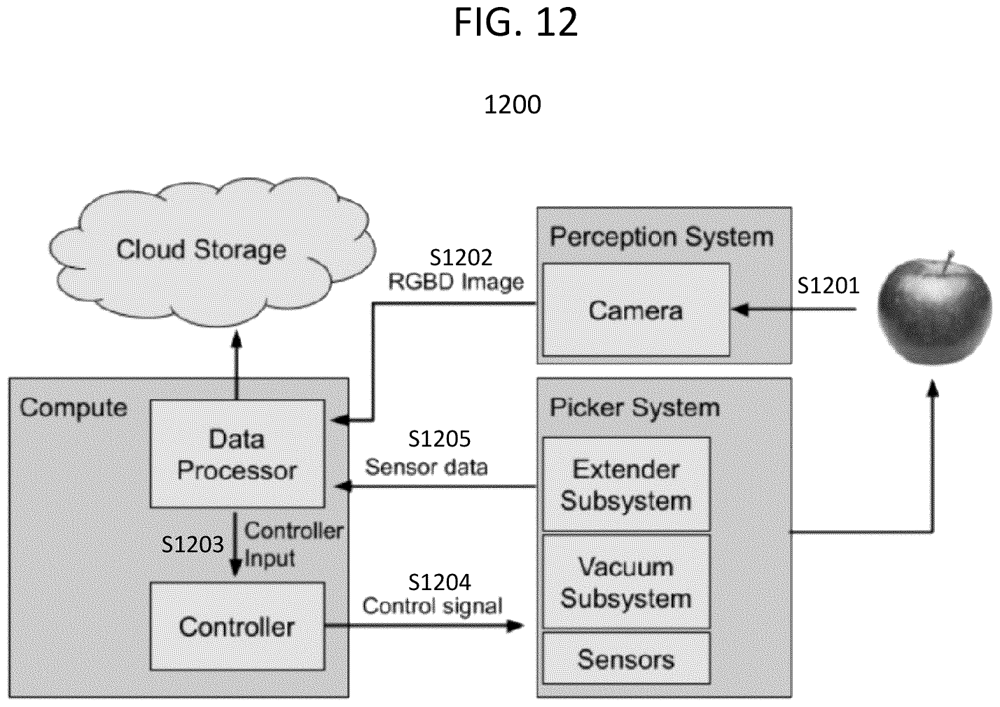

FIG. 12 illustrates a process 1200 of operating the automated picking apparatus 100. FIG. 12 illustrates an example embodiment of a process 1200 of operations performed by the automated picking apparatus 100. When the automated picking apparatus 100 according to the example embodiment of FIG. 1 is extended into a tree bearing fruit the stereo camera(s) 140 will search (S1201) for a piece of fruit in the tree using a perception system with the camera(s) 140. When the camera(s) 140 detects a piece of fruit it will capture image data of the fruit and transmit the captured data (S1202) to a data processor contained within the computer processor system. The transmitted image data from the camera(s) 140 can include location data (in the x, y and z spaces) of the to-be-picked fruit with respect to the camera 140, fruit type classification, fruit ripeness classification, as well as other useful information extractable from the image data. The data processor will process the image data and transmit (S1203) the processed data to a controller, which will generate control signals and transmit (S1204) the generated control signals to the automated fruit picking apparatus 100. At the same time the control signals are being transmitted to the vacuum system to control closing and opening of vacuum valves and to control the DC motors 109 of shooter assemblies 104 to providing accurate positioning of the vacuum cup 110 with respect to the detected fruit. Sensors on the vacuum cup 110 will continuously sense the positioning of the vacuum cup 110 with respect to the piece of fruit detected and transmit (S1205) sensor data to the data processor via Step (S1205). As a result of the continuous sensor data being received by the data processor via Step (S1205), the data processor will continue to process the received sensor data and transmit (S1203) the processed sensor data to the controller together with the image data received from the camera 140. The processed sensor data will cause the controller to generate signals which cause more controlled actions of the DC motors 109 to provide more delicate movements of the vacuum cup 110 so that a soft contact will be made between the vacuum cup 110 and the fruit, thus avoiding bruising the fruit. It is to be noted that the computer processor system can be embedded within the main body 102 of the automated picking apparatus 100, or alternatively can be a separate unit which wirelessly receives the image data and sensor data. The outputs of the processed data can also be stored in a Cloud storage.

FIG. 13 illustrates an automated fruit picking system 300 according to an example embodiment of the present inventive concept. In this example embodiment the automated fruit picking system 300 can include the automated fruit picking apparatus 100, a crane 305 (i.e., a robotic arm) connected thereto to electromechanically control the position of the automated fruit picking apparatus 100, a crane vest 310 connected to the crane 305 and configured to be worn by a human fruit picker. Connected to the automated fruit picking apparatus 100 can be a chute 320 to receive fruit picked by the automated fruit picking apparatus 100 and a fruit transported 330 which receives fruit through the chute 320 for transportation of the collected fruit.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An automated fruit picking apparatus, comprising:
a main body formed of a rigid material;
at least two shooter assemblies fixed to different sides of the main body, the at least two shooter assemblies each including:
a shooter extender housing attached to a side of the main body;
at least one pair of rotatable guide bearings disposed adjacent to each other within the shooter extender housing to guide movement of a flexible cable to extend out through and retract back through the shooter extender housing;
a driver roller configured to drive a flexible cable back and forth through the shooter extender housing between the at least one pair of rotatable guide bearings;
a driver motor connected to the shooter extender housing and to the driver roller to rotate the driver roller; and
an integrated digitally programmed rotary encoder to control rotation of the driver motor;
a flexible cable extending through each of the at least two shooter assemblies between the at least one pair of guide bearings and against the drive roller;
a cable adapter assembly connected at a first side thereof to a first end of each flexible cable;
a vacuum cup connected to a second side of the cable adapter assembly; and
a stereo vision camera connected to a front of the main body to sense a position of a piece of fruit, to capture image data of the piece of fruit, and to send the captured image data to the integrated digitally programmed rotary encoder to control rotation of each drive motor of the at least two shooter assemblies to control positioning of the cable adaptor assembly and vacuum cup.

2. The automated fruit picking apparatus according to claim 1, wherein the at least two shooter assemblies includes four shooter assemblies, each shooter assembly being fixed to a different side of the main body.

3. The automated fruit picking apparatus according to claim 2, further comprising:
a reset trigger attached to the flexible cable between one side of the corresponding shooter extender housing and the cable adapter assembly;
a cable end stopper attached to the flexible cable at an opposite side of the corresponding shooter extender housing; and
a trigger limit switch to trigger and stop the drive motor when the trigger limit switch detects the reset trigger indicating that the flexible cable has been fully retracted through the shooter extender housing and when the trigger limit switch detects the cable end stopper indicating that the flexible cable has been fully extended through the shooter extender housing.

4. The automated fruit picking apparatus according to claim 2, wherein the at least one pair of guide bearings disposed adjacent to each other includes two pairs of guide bearings, a first pair of guide bearings being disposed at a first end of the shooter extender housing and a second pair of guide bearings being disposed at a second opposite end of the shooter extender housing such that the corresponding flexible cable extends through each of the pairs of the guide bearings and the drive roller is disposed between the first and second pair of guide bearings.

5. The automated fruit picking apparatus according to claim 4, further comprising:
a compression joint assembly disposed against the drive roller to apply a compression force on the flexible cable to stay in frictional contact with the drive roller.

6. The automated fruit picking apparatus according to claim 5, wherein the compression joint assembly comprises:
a compression bracket rotatably supporting and compressing a guide bearing to press a flexible cable against the drive roller;
a compression spring to apply a compression force between the main body and the compression bracket; and
a spring adjuster to adjust the compression force applied by the compression spring.

7. The automated fruit picking apparatus according to claim 2, wherein the main body is formed of sheet metal.

8. The automated fruit picking apparatus according to claim 1, wherein the integrated digitally programmed rotary encoder is configured to register the number of revolutions the motor has rotated to determine the distance that the flexible cable has extended and retracted.

9. The automated fruit picking apparatus according to claim 1, further comprising;
a computer operated robotic arm assembly connected thereto to the main body to raise and lower the main body based on image data received from the stereo vision camera.

10. An automated fruit picking system, comprising:
a main body having four sides;
a shooter assembly fixed to each of the four sides of the main body, each shooter assembly including:
a shooter extender housing attached to one side of the main body;
a driver roller rotatably fixed to the shooter extender housing and configured to frictionally drive a flexible cable to extend out through the shooter extender housing and retract back through the shooter extender housing;
a compression assembly fixed to the shooter extender housing to apply a continuous force to a flexible cable against the drive roller; and
a digitally controlled rotary encoder driver motor connected to the main body and the driver roller to control precise rotation of the driver roller;
a flexible cable extending between the drive roller and the compression assembly;
a cable adapter assembly connected at a first side thereof to a first end of each flexible cable;
a fruit suction device to suction fruit thereto connected to a second side of the cable adapter assembly; and
a stereo vision camera connected to a front end of the main body to sense a position of a piece of fruit, to capture image data of the piece of fruit, and to send the captured image data to each digitally controlled rotary encoder driver motor to control rotation of each digitally controlled rotary encoder driver motor to control positioning of each corresponding flexible cable, the cable adaptor assembly and the vacuum cup.

11. The automated fruit picking system according to claim 10, further comprising:
an adjacent pair of rotatable guide bearings disposed at two opposite sides of the driver roller and compression assembly combination to each receive the flexible cable therebetween to guide the movement of the flexible cable to extend out through the shooter extender housing and retract back through the shooter extender housing.

12. The automated fruit picking apparatus according to claim 10, further comprising:
a reset trigger attached to the flexible cable between one side of the corresponding shooter extender housing and the cable adapter assembly;
a cable end stopper attached to the flexible cable at an opposite side of the corresponding shooter extender housing; and
a trigger limit switch to trigger and stop the drive motor when the trigger limit switch detects the reset trigger indicating that the flexible cable has been fully retracted through the shooter extender housing and when the trigger limit switch detects the cable end stopper indicating that the flexible cable has been fully extended through the shooter extender housing.

13. The automated fruit picking apparatus according to claim 10, wherein the compression joint assembly comprises:
a compression bracket rotatably supporting and compressing a guide bearing to press a flexible cable against the drive roller;
a compression spring to apply a compression force between the main body and the compression bracket; and
a spring adjuster to adjust the compression force applied by the compression spring.

14. The automated fruit picking apparatus according to claim 10, wherein the fruit suction device is a vacuum cup configured to draw air inward through the vacuum cup to suction the fruit.

15. A method of automatically picking fruit from a tree, the method comprising:
controlling the extension, retraction and the positional direction of the vacuum cup assembly by:
capturing image data of a location of a piece of fruit with an image capturing device;
transmitting the captured image data to at least two digitally controlled rotary encoded driver motors, the image data being executed to control the rotation of the at least two digitally controlled rotary encoded driver motors;
rotating at least two driver rollers by the corresponding at least two digitally controlled rotary encoded driver motors to rotate a corresponding driver roller to frictionally extend and retract a corresponding flexible cable; and
extending, retracting and pointing the vacuum cup assembly in different directs with the extension and retraction of each flexible cable by connecting each flexible cable to a different location on the vacuum cup assembly.

16. The method according to claim 15, further comprising;
guiding the flexible cables through two pairs of guide bearings, each pair of guide bearings receiving a corresponding flexible cable therethrough to guide the direction of the corresponding flexible cable.

17. The method according to claim 15, further comprising:
applying a continuous compression force to the flexible cable against the corresponding driver roller to maintain a friction between the flexible cable and the driver roller.

18. The method according to claim 15, further comprising:
raising and lowering the vacuum cup assembly, the image capturing device, the at least two digitally controlled rotary driver motors and corresponding driver roller with a computer controlled robotic arm assembly in accordance with the captured image data.
